(19) United States
(12) Patent Application Publication
(10) Pub. No.: US 2024/0413466 A1
(43) Pub. Date: Dec. 12, 2024

(54) BATTERY DEVICE AND WORK MACHINE

(71) Applicant: KOMATSU LTD., Tokyo (JP)

(72) Inventors: Satoshi FUJIMOTO, Tokyo (JP); Takafumi MATSUYAMA, Tokyo (JP); Shoya KIMURA, Tokyo (JP)

(21) Appl. No.: 18/717,180

(22) PCT Filed: Nov. 30, 2022
(86) PCT No.: PCT/JP2022/044144

§ 371 Date: Jun. 6, 2024

(30) Foreign Application Priority Data
Jan. 31, 2022 (JP) 2022-013318

(51) Int. Cl. H01M 50/264; H01M 50/249

(52) U.S. Cl. CPC H01M 50/264; H01M 50/249; H01M 2220/20

(57) ABSTRACT

A battery device includes a plurality of battery assemblies. Each battery assembly has a battery pack containing a plurality of batteries, and one or more brackets attached to a side surfaces of the battery packs. The plurality of battery assemblies are stacked in an up-down direction. At least one battery assembly of the plurality of battery assemblies has two upper level fixing parts that are fixed to a battery assembly positioned in a level above, and two lower level fixing parts that are fixed to a battery assembly positioned in a level below. A distance between the two upper level fixing parts and a distance between the two lower level fixing parts are different.

### CROSS-REFERENCE TO RELATED APPLICATIONS

This application is a U.S. National stage application of International Application No. PCT/JP2022/044144, filed on Nov. 30, 2022. This U.S. National stage application claims priority under 35 U.S.C. § 119(a) to Japanese Patent Application No. 2022-013318, filed in Japan on Jan. 31, 2022, the entire contents of which are hereby incorporated herein by reference.

### BACKGROUND

### Technical Field

The present disclosure relates to a battery device and a work machine.

### Background Information

Japanese Patent Laid-open No. 2012-202065 discloses an electric shovel as an example of a work machine. The electric shovel comprises an electric motor driven by electric power stored in a battery device instead of an engine that is conventionally provided to a hydraulic shovel. The electric motor drives a hydraulic pump for supplying pressure oil to hydraulic cylinders for a work implement.

In electric shovels, there is a need to minimize the turning radius while it is also necessary to have multiple batteries for driving the electric motor.

In the battery device of Japanese Patent Laid-open No. 2012-202065, a plurality of battery packs that contain a plurality of batteries are stacked in the up-down direction and the battery packs are fixed from the side by fixing bolts to posts that rise up from a revolving frame.

### SUMMARY

However, it is difficult to access the fixing bolts from the side because the battery device is surrounded by other structural members.

As a result, when there is a need to replace a battery pack, the entire battery device must be removed from the outside of the work machine after detaching the posts from the revolving frame, which is bothersome.

An objective of the present disclosure is to provide a battery device and a work machine in which a battery pack can be replaced easily.

A battery device according to a first embodiment of the present disclosure comprises a plurality of battery assemblies. Each of the plurality of battery assemblies has a battery pack and a bracket. The battery pack contains a plurality of batteries. The bracket is attached to a side surface of the battery pack. At least one battery assembly among the plurality of battery assemblies has two upper level fixing parts that are fixed to a battery assembly located in a level above, and two lower level fixing parts that are fixed to a battery assembly located in a level below. A distance between the two upper level fixing parts and a distance between the two lower level fixing parts are different.

A battery device according to a second embodiment of the present disclosure is related to the first embodiment, and each of the plurality of battery assemblies has the two upper level fixing parts and the two lower level fixing parts. The distance from the center in the extension direction of the side surface to the two upper level fixing parts is less than the distance from the center to the two lower level fixing parts. The positions of the two upper level fixing parts in the extension direction match the positions of the two lower level fixing parts of the battery assembly positioned in the level above. The positions of the two lower level fixing parts in the extension direction match the positions of the two upper level fixing parts of the battery assembly positioned in the level below.

A battery device according to a third embodiment of the present disclosure is related to the second embodiment and the intervals between the two upper level fixing parts in the extension direction increase toward the lower levels. The intervals between the two lower level fixing parts in the extension direction increase toward the lower levels in the plurality of brackets.

A battery device according to a fourth embodiment of the present disclosure comprises a plurality of battery assemblies and a plurality of fixing bolts. The plurality of battery assemblies each have a battery pack that contains a plurality of batteries, and one or more brackets attached to a side surface of the battery pack, and the plurality of battery assemblies are stacked in an up-down direction. The plurality of fixing bolts fix the plurality of battery assemblies to each other. All of the head top surfaces of the plurality of fixing bolts can be seen in a top view or a bottom view.

A battery device according to a fifth embodiment of the present disclosure is related to the fourth embodiment, and the plurality of fixing bolts are aligned side by side in order according to respective positions in the up-down direction in the top view or the bottom view.

A battery device according to a sixth embodiment of the present disclosure is related to the fifth embodiment and each of the brackets is fixed by two fixing bolts aligned side by side in an extension direction of the side surface. Two fixing bolts for fixing one bracket among the plurality of brackets are positioned on the inside the two fixing bolts for fixing another bracket positioned in a level below the one bracket among the plurality of brackets in a top view or a bottom view.

A work machine according to a seventh embodiment of the present disclosure comprises a travel mechanism, a vehicle body frame, a work implement unit, an electric motor, and the battery device described in any one of the first to sixth embodiments. The vehicle body frame is supported by the travel mechanism. The work implement unit has a work implement and a work implement driving unit. The electric motor causes the travel mechanism and the work implement unit to operate. The battery device supplies electrical power to the electric motor.

According to the present disclosure, there is provided a battery device and a work machine in which a battery pack can be replaced easily.

### BRIEF DESCRIPTION OF THE DRAWINGS

FIG. 1 is a perspective view of an electric shovel according to an embodiment.

FIG. 2 is an exploded perspective view of a battery device according to the embodiment.

FIG. 3 is a rear view of the battery device according to the embodiment.

FIG. 4 is a top view of the battery device according to the embodiment.

### . DETAILED DESCRIPTION OF EMBODIMENT(S)

### (Electric Shovel)

A configuration of an electric shovel 1 (example of a “work machine”) according to the present embodiment is explained with reference to the drawings.

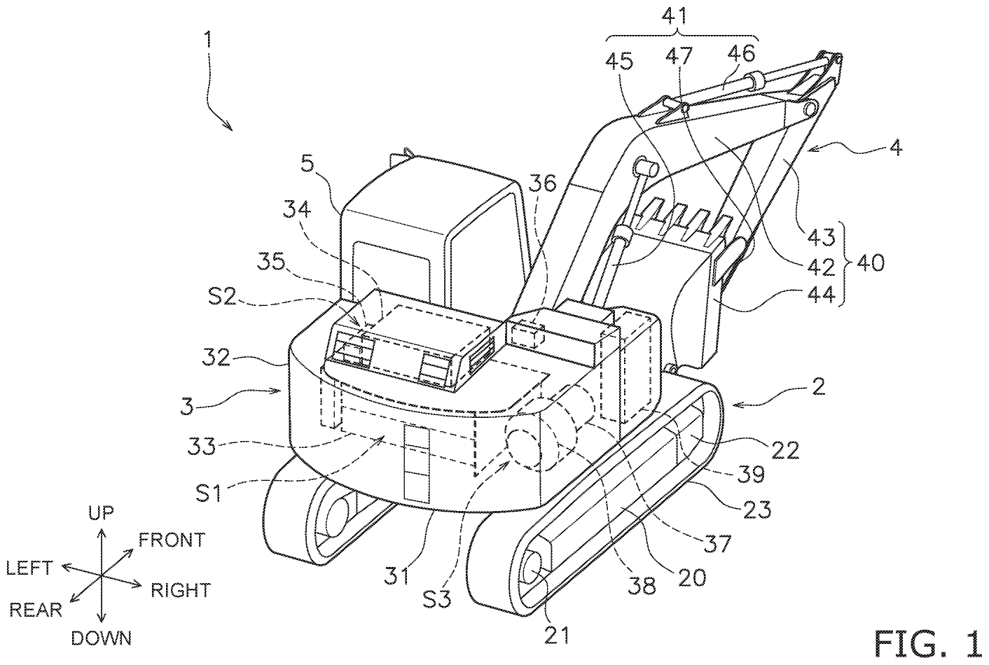

FIG. 1 is a perspective view illustrating the electric shovel 1 from behind and to the right. In the present description, “up” and “down” respectively signify upward and downward in the vertical direction. In the present description, “front” and “rear” respectively signify forward and rearward in the front-back direction of the electric shovel 1, and “left” and “right” respectively signify leftward and rightward when viewing toward the front of the electric shovel 1.

As illustrated in FIG. 1, the electric shovel 1 comprises an undercarriage 2, a rotating super structure 3, a work implement unit 4, and a cab 5.

The undercarriage 2 includes track frames 20, and drive wheels 21, driven wheels 22, and crawler belts 23. The track frames 20 extend in the front-back direction. The drive wheels 21 are supported at a rear end part of each track frame 20. The driven wheels 22 are supported at a front end part of each track frame 20. The crawler belts 23 are stretched across the drive wheels 21 and the driven wheels 22.

The rotating super structure 3 is disposed above the undercarriage 2. The rotating super structure 3 is provided in a rotatable manner with respect to the undercarriage 2. The rotating super structure 3 has a rotating frame 31 (example of a “vehicle body frame”) and a vehicle body cover 32. The rotating frame 31 is disposed above the undercarriage 2. The rotating frame 31 is supported by the undercarriage 2. The vehicle body cover 32 covers a space above the rotating frame 31. In FIG. 1, the vehicle body cover 32 is depicted as transparent so as to be able to see the inside thereof. The inside of the vehicle body cover 32 is partitioned into a first region S1, a second region S2, and a third region S3. The first region S1, the second region S2, and the third region S3 do not need to be completely separated and may be joined to each other.

A battery device 33 is disposed in the first region S1. The battery device 33 is disposed in a rear upper end part of the rotating frame 31. The battery device 33 also functions as a counterweight that is provided to a conventional hydraulic excavator. A configuration of the battery device 33 is discussed below.

The second region S2 is provided above the first region S1. A battery thermal management system (BTMS) 34 and a DC/DC converter 35 are disposed in the second region S2. The BTMS 34 controls the battery device 33 so as to be within a desired temperature range in order to suppress heat deterioration of the battery device 33. The DC/DC converter 35 steps down the voltage of the direct current power supplied from the battery device 33.

The third region S3 is provided to the side of the first region S1 and the second region S2. An inverter 36, an electric motor 37, a hydraulic pump 38, and a control valve 39 are disposed in the third region S3. The inverter 36 includes an inverter circuit that converts the direct current power supplied from the DC/DC converter 35 to an alternating current power of a desired frequency, and a microcomputer that controls the inverter circuit. The electric motor 37 drives with the alternating current power supplied from the inverter 36. The electric motor 37 causes the undercarriage 2 and the work implement unit 4 to operate. Specifically, the electric motor 37 causes the undercarriage 2 and the work implement unit 4 to operate by driving the hydraulic pump 38 to supply pressure oil to the undercarriage 2 and the work implement unit 4. The hydraulic pump 38 is driven by the electric motor 37. The hydraulic pump 38 supplies the pressure oil to the undercarriage 2 and the work implement unit 4 through the control valve 39.

The work implement unit 4 has a work implement 40 and a work implement driving unit 41. The work implement 40 has a boom 42, an arm 43, and a bucket 44. The work implement driving unit 41 includes a boom cylinder 45, an arm cylinder 46, and a bucket cylinder 47. The boom cylinder 45, the arm cylinder 46, and the bucket cylinder 47 operate by means of pressure oil supplied from the hydraulic pump 38.

The cab 5 is disposed on a front end part of the rotating frame 31. A seat for an operator to sit in and various operating levers for operating the undercarriage 2 and the work implement unit 4, etc., are disposed inside the cab 5.

### (Battery Device)

A configuration of the battery device 33 according to the present embodiment will be discussed with reference to the drawings.

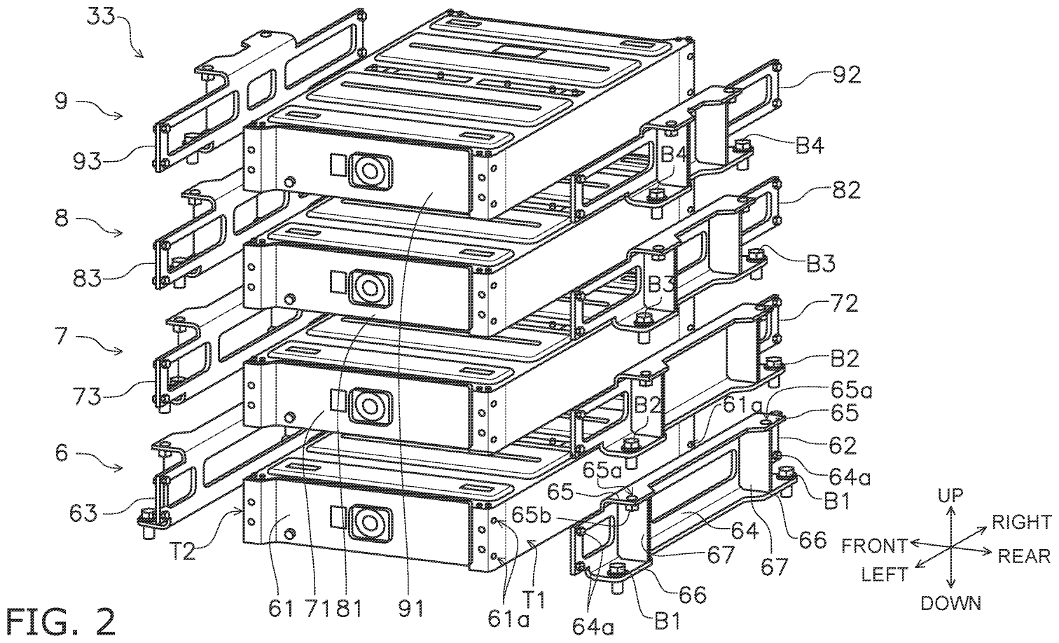

FIG. 2 is an exploded perspective view of the battery device 33.

The battery device 33 according to the present embodiment comprises first to fourth battery assemblies 6 to 9. The first to fourth battery assemblies 6 to 9 are stacked in the up-down direction. The first to fourth battery assemblies 6 to 9 are disposed in order from the bottom. The first battery assembly 6 is the battery assembly on the lowermost level and the fourth battery assembly 9 is the battery assembly on the uppermost level. In the present description, being stacked in the up-down direction signifies that two members are adjacent to each other vertically and is a concept that includes a mode in which two members are in direct contact and a mode in which two members are present with an interval therebetween.

As illustrated in FIG. 2, the first battery assembly 6 includes a first battery pack 61, a first rear bracket 62, and a first front bracket 63. The second battery assembly 7 includes a second battery pack 71, a second rear bracket 72, and a second front bracket 73. The third battery assembly 8 includes a third battery pack 81, a third rear bracket 82, and a third front bracket 83. The fourth battery assembly 9 includes a fourth battery pack 91, a fourth rear bracket 92, and a fourth front bracket 93.

The first to fourth battery packs 61, 71, 81, and 91 are stacked in the up-down direction. The first to fourth battery packs 61, 71, 81, and 91 are stacked in order from the bottom. The first to fourth battery packs 61, 71, 81, and 91 are electrically connected whereby a battery circuit is configured.

The first to fourth rear brackets 62, 72, 82, and 92 are stacked in the up-down direction. The first to fourth rear brackets 62, 72, 82, and 92 are stacked in order from the bottom. The first to fourth rear brackets 62, 72, 82, and 92 are an example of the “plurality of brackets.”

The first to fourth front brackets 63, 73, 83, and 93 are stacked in the up-down direction. The first to fourth front brackets 63, 73, 83, and 93 are stacked in order from the bottom. The first to fourth front brackets 63, 73, 83, and 93 are an example of the “plurality of brackets.”

The basic configurations of the first to fourth battery assemblies 6 to 9 are shared and the basic configuration of the first battery assembly 6 is discussed as a representative configuration.

The first battery pack 61 contains therein a plurality of batteries (not illustrated). The plurality of batteries are aligned side by side in the transverse direction inside the first battery pack 61. In the present embodiment, the outer profile of the first battery pack 61 is a rectangular solid that extends in the left-right direction. The first battery pack 61 has a rear surface T1 and a front surface T2. The rear surface T1 and the front surface T2 are both examples of a “side surface.” In the present embodiment, the rear surface T1 and the front surface T2 both extend longer in the left-right direction. Two coupling holes 61a are respectively formed at both end parts of the rear surface T1. While not illustrated, two coupling holes 61a are also respectively formed at both end parts of the front surface T2.

The first rear bracket 62 is attached to the rear surface T1 of the first battery pack 61. The first rear bracket 62 supports the first battery pack 61 from the rear.

The first rear bracket 62 includes a body part 64, two upper level fixing parts 65, two lower level fixing parts 66, and two ribs 67.

The body part 64 is formed as a plate. The body part 64 extends longer in the left-right direction. The body part 64 is disposed along the rear surface T1 of the first battery pack 61. Two insertion holes (not illustrated) that are open in the front and rear are formed at both end parts of the body part 64, and coupling bolts 64a are inserted into the insertion holes. The coupling bolts 64a are screwed into the coupling holes 61a formed on the rear surface T1 of the first battery pack 61. As a result, the first rear bracket 62 is coupled to the first battery pack 61.

The two upper level fixing parts 65 are separate from each other in the extension direction (the left-right direction in the present embodiment) of the rear surface T1. The upper level fixing parts 65 are formed as plates. The upper level fixing parts 65 protrude toward the rear from the upper end part of the body part 64. One insertion hole 65a that opens vertically is formed in each of the upper level fixing parts 65. Nuts 65b are fixed at positions matching the openings of the insertion hole 65a on the bottom surface of the upper level fixing parts 65. Below mentioned second fixing bolts B2 are tightened and fixed to the nuts 65b. As a result, the second rear bracket 72 positioned above is fixed to the first rear bracket 62.

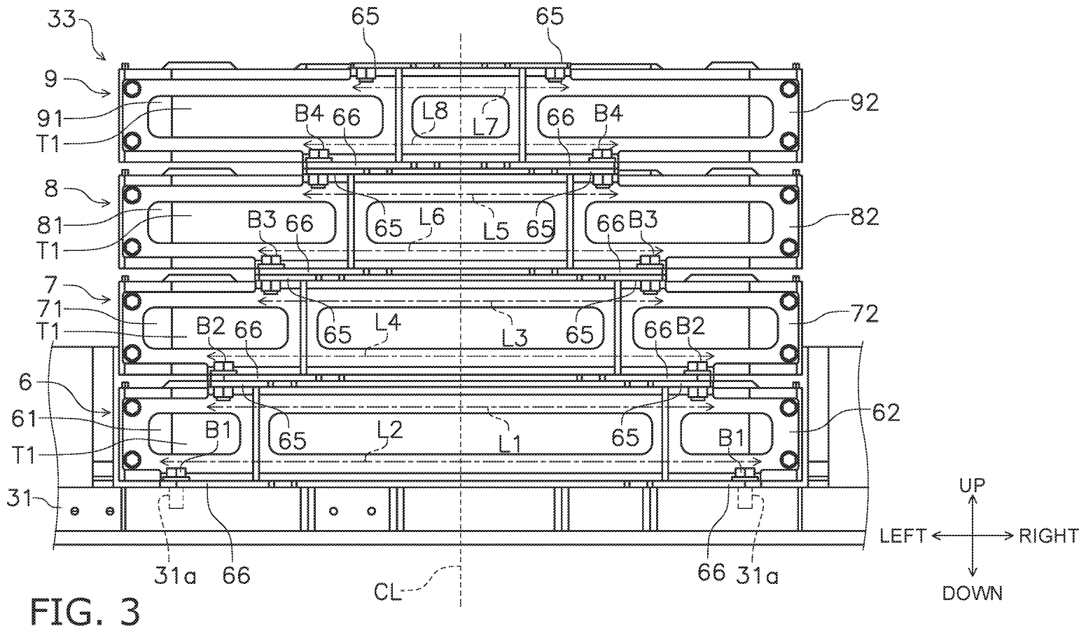

The two lower level fixing parts 66 are separated from each other in the extension direction of the rear surface T1. The lower level fixing parts 66 are formed as plates. The lower level fixing parts 66 protrude toward the rear from the lower end part of the body part 64. One insertion hole that opens upward and downward is formed in each of the lower level fixing parts 66, and below mentioned first fixing bolts B1 are inserted into the insertion holes. The first fixing bolts B1 are screwed into fixing holes 31a (see FIG. 3) formed on the upper surface of the rotating frame 31. As a result, the first rear bracket 62 is fixed to the rotating frame 31.

The two ribs 67 are spaced away from each other in the extension direction of the rear surface T1. The ribs 67 are formed as a plates. The ribs 67 are connected to the upper level fixing parts 65 and the lower level fixing parts 66. The ribs 67 are reinforcing members of the upper level fixing parts 65 and the lower level fixing parts 66.

The first front bracket 63 is attached to the front surface T2 of the first battery pack 61. The first front bracket 63 supports the first battery pack 61 from the front. The configuration of the first front bracket 63 is the same as the configuration of the first rear bracket 62.

### (Bracket Fixing Structure)

Next, a structure for fixing the brackets to each other will be discussed with reference to the drawings. The fixing structures of the first to fourth rear brackets 62, 72, 82, and 92 are the same as the fixing structures of the first to fourth front brackets 63, 73, 83, and 93. Consequently, the fixing structures of the first to fourth rear brackets 62, 72, 82, and 92 will be discussed below.

FIG. 3 is a rear view of the battery device 33 disposed on the rotating frame 31.

Each of the first to fourth rear brackets 62, 72, 82, and 92 are fixed to each other by two fixing bolts. As a result, the first to fourth battery assemblies 6 to 9 are fixed together. Specifically, the fixing is performed as explained below.

The first rear bracket 62 is disposed on the rotating frame 31. Each of the lower level fixing parts 66 of the first rear bracket 62 are fixed to the rotating frame 31 with the first fixing bolts B1. The two first fixing bolts B1 are aligned in the extension direction of the rear surface T1 of the first battery pack 61.

The second rear bracket 72 is disposed on the first rear bracket 62. The lower level fixing parts 66 of the second rear bracket 72 are fixed to the upper level fixing parts 65 of the first rear bracket 62 with the second fixing bolts. The two second fixing bolts B2 are aligned in the extension direction of the rear surface T1 of the second battery pack 71.

The third rear bracket 82 is disposed on the second rear bracket 72. The lower level fixing parts 66 of the third rear bracket 82 are fixed to the upper level fixing parts 65 of the second rear bracket 72 with third fixing bolts B3. The two third fixing bolts B3 are aligned in the extension direction of the rear surface T1 of the third battery pack 81.

The fourth rear bracket 92 is disposed on the third rear bracket 82. The lower level fixing parts 66 of the fourth rear bracket 92 are fixed to the upper level fixing parts 65 of the third rear bracket 82 with fourth fixing bolts B4. The two fourth fixing bolts B4 are aligned in the extension direction of the rear surface T1 of the fourth battery pack 91.

The distance L1 between the two upper level fixing parts 65 is different from the distance L2 between the two lower level fixing parts 66 in the first rear bracket 62. Specifically, the distance L1 between the two upper level fixing parts 65 is less than the distance L2 between the lower level fixing parts 66. The distance (half of L1) from the center CL of the rear surface T1 in the extension direction of the rear surface T1 to the two upper level fixing parts 65 is less than the distance (half of L2) from the center CL to the two lower level fixing parts 66.

The distance L3 between the two upper level fixing parts 65 is different from the distance L4 between the two lower level fixing parts 66 in the second rear bracket 72. Specifically, the distance L3 between the two upper level fixing parts 65 is less than the distance L4 between the lower level fixing parts 66. The distance (half of L3) from the center CL to the two upper level fixing parts 65 is less than the distance (half of L4) from the center CL to the two lower level fixing parts 66.

The distance L5 between the two upper level fixing parts 65 is different from the distance L6 between the two lower level fixing parts 66 in the third rear bracket 82. Specifically, the distance L5 between the two upper level fixing parts 65 is less than the distance L6 between the lower level fixing parts 66. The distance (half of L5) from the center CL to the two upper level fixing parts 65 is less than the distance (half of L6) from the center CL to the two lower level fixing parts 66.

The distance L7 between the two upper level fixing parts 65 is different from the distance L8 between the two lower level fixing parts 66 in the fourth rear bracket 92. Specifically, the distance L7 between the two upper level fixing parts 65 is less than the distance L8 between the lower level fixing parts 66. The distance (half of L7) from the center CL to the two upper level fixing parts 65 is less than the distance (half of L8) from the center CL to the two lower level fixing parts 66.

The respective distances from the center CL to the two upper level fixing parts 65 are equal and the respective distances from the center CL to the two lower level fixing parts 66 are equal in the first to fourth rear brackets 62, 72, 82, and 92.

The positions of the two upper level fixing parts 65 of the second rear bracket 72 in the extension direction of the rear surface T1 match the positions of the two lower level fixing parts 66 of the third rear bracket 82 positioned in the level above the second rear bracket 72. The distance L3 between the two upper level fixing parts 65 of the second rear bracket 72 is the same as the distance L6 between the two lower level fixing parts 66 of the third rear bracket 82.

The positions of the two lower level fixing parts 66 of the second rear bracket 72 in the extension direction of the rear surface T1 match the positions of the two upper level fixing parts 65 of the first rear bracket 62 positioned in the level below the second rear bracket 72. The distance L4 between the two lower level fixing parts 66 of the second rear bracket 72 is the same as the distance L1 between the two upper level fixing parts 65 of the first rear bracket 62.

The positions of the two upper level fixing parts 65 of the third rear bracket 82 in the extension direction of the rear surface T1 match the positions of the two lower level fixing parts 66 of the fourth rear bracket 92 positioned in the level above the third rear bracket 82. The distance L5 between the two upper level fixing parts 65 of the third rear bracket 82 is the same as the distance L8 between the two lower level fixing parts 66 of the fourth rear bracket 92.

The positions of the two lower level fixing parts 66 of the third rear bracket 82 in the extension direction of the rear surface T1 match the positions of the two upper level fixing parts 65 of the second rear bracket 72 positioned in the level below the third rear bracket 82. The distance L6 between the two lower level fixing parts 66 of the third rear bracket 82 is the same as the distance L3 between the two upper level fixing parts 65 of the second rear bracket 72.

The intervals between the two upper level fixing parts 65 in the extension direction increase toward the lower levels in the first to fourth rear brackets 62, 72, 82, and 92. Specifically, the distance L5 between the two upper level fixing parts 65 of the third rear bracket 82 is greater than the distance L7 between the two upper level fixing parts 65 of the fourth rear bracket 92. The distance L3 between the two upper level fixing parts 65 of the second rear bracket 72 is greater than the distance L5 between the two upper level fixing parts 65 of the third rear bracket 82. The distance L1 between the two upper level fixing parts 65 of the first rear bracket 62 is greater than the distance L3 between the two upper level fixing parts 65 of the second rear bracket 72.

The intervals between the two lower level fixing parts 66 in the extension direction increase toward the lower levels in the first to fourth rear brackets 62, 72, 82, and 92. Specifically, the distance L6 between the two lower level fixing parts 66 of the third rear bracket 82 is greater than the distance L8 between the two lower level fixing parts 66 of the fourth rear bracket 92. The distance L4 between the two lower level fixing parts 66 of the second rear bracket 72 is greater than the distance L6 between the two lower level fixing parts 66 of the third rear bracket 82. The distance L2 between the two lower level fixing parts 66 of the first rear bracket 62 is greater than the distance L4 between the two lower level fixing parts 66 of the second rear bracket 72.

The distance between the two upper level fixing parts in the present description is the distance between the two outermost edges of the upper level fixing parts in the extension direction of the rear surface T1. Similarly, the distance between the two lower level fixing parts is the distance between the two outermost edges of the lower level fixing parts in the extension direction of the rear surface T1.

### (Disposition of Fixing Bolts)

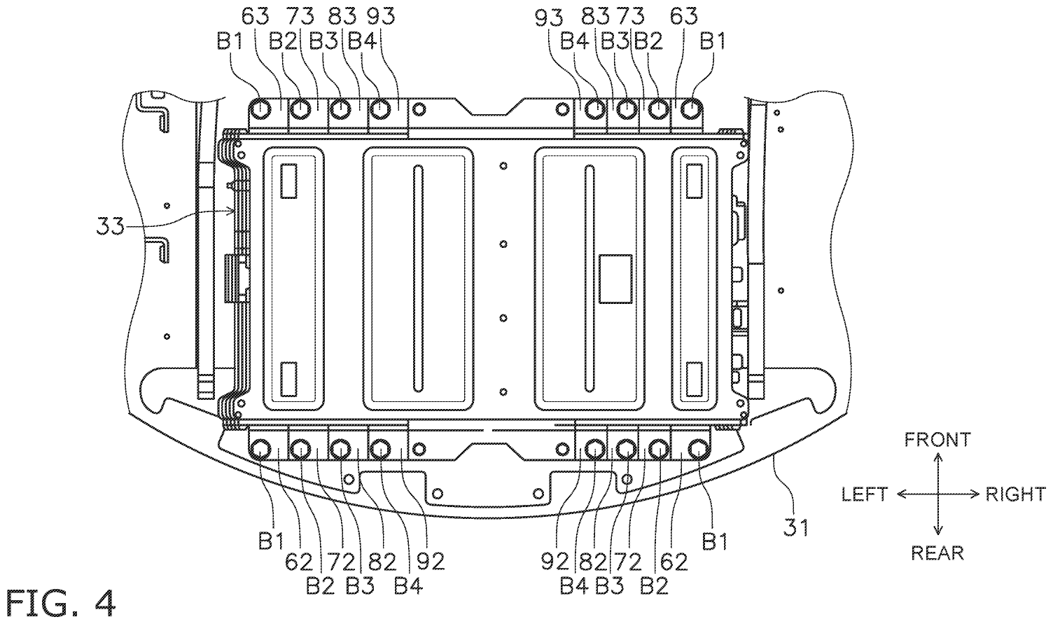

FIG. 4 is a top view of the battery device 33 disposed on the rotating frame 31.

As illustrated in FIG. 4, the respective head top surfaces of the first to fourth fixing bolts B1 to B4 for fixing the respective first to fourth rear brackets 62, 72, 82, and 92 can be seen in the top view of the battery device 33. The head top surfaces of the fixing bolts signify the main surfaces of the bolt heads.

Similarly, the respective head top surfaces of the first to fourth fixing bolts B1 to B4 for fixing the respective first to fourth front brackets 63, 73, 83, and 93 can be seen in the top view of the battery device 33.

In this way, all of the fixing bolts B1 to B4 can be accessed by a tool from above because all of the head top surfaces of the fixing bolts B1 to B4 for fixing the brackets are exposed from above. Therefore, whenever it is necessary to replace any of the battery packs, the battery pack to be replaced can be replaced easily.

For example, the following work is performed when replacing the second battery pack 71.

First, the two second fixing bolts B2 for fixing the second rear bracket 72 to the first rear bracket 62, and the two second fixing bolts B2 for fixing the second front bracket 73 to the first front bracket 63 are removed using an impact wrench that is inserted from above the battery device 33.

Next, the second to fourth battery assemblies 7 to 9 are removed as one from the first region S1 to the outside.

Next, the two third fixing bolts B3 for fixing the third rear bracket 82 to the second rear bracket 72 and the two third fixing bolts B3 for fixing the third front bracket 83 to the second front bracket 73 are removed, and the second battery assembly 7 is taken out.

Next, the second battery pack 71 of the second battery assembly 7 is replaced with a new second battery pack 71.

Next, the third and fourth battery assemblies 8 and 9 are placed as one on the second battery assembly 7, and the second to fourth battery assemblies 7 to 9 are put together again by tightening and fixing the four third fixing bolts B3.

Next, the second to fourth battery assemblies 7 to 9 are returned as one to the first region S1, and the first to fourth battery assemblies 6 to 9 are put together again by tightening and fixing the four second fixing bolts B2.

In this way, the second battery pack 71 can be replaced easily because the work can be performed while the first battery assembly 6 remains in the first region S1.

The ability to see the respective head top surfaces of the first to fourth fixing bolts B1 to B4 is due to the positions of the respective upper level fixing parts 65 and the respective lower level fixing parts 66 of the first to fourth rear brackets 62, 72, 82, and 92 and the first to fourth front brackets 63, 73, 83, and 93 being suitably arranged as discussed above.

As illustrated in FIG. 4, the first to fourth fixing bolts B1 to B4 are preferably aligned side by side in order according to the respective positions in the up-down direction. In the present embodiment, the first to fourth fixing bolts B1 to B4 are disposed in this order from the bottom (see FIG. 3), whereby the first to fourth fixing bolts B1 to B4 are also disposed in this order in the top view of the battery device 33 as illustrated in FIG. 4.

By matching the order in the up-down direction and the order in the top view of the first to fourth fixing bolts B1 to B4 in this way, the fixing bolts to be removed can be easily identified when accessed with a tool from above.

As illustrated in FIG. 4, two fixing bolts for fixing one bracket among the first to fourth rear brackets 62, 72, 82, and 92 are preferably positioned inside the two fixing bolts for fixing another bracket positioned therebelow in the top view of the battery device 33. Specifically, the two second fixing bolts B2 for fixing the second bracket 72 are preferably positioned inside the two first fixing bolts B1 for fixing the first bracket 62 in the extension direction. Similarly, the two third fixing bolts B3 are preferably positioned inside the two second fixing bolts B2, and the two fourth fixing bolts B4 are preferably positioned inside the two third fixing bolts B3. By disposing the fixing bolts in such a manner, the fixing bolts to be removed can be easily identified when accessed with a tool from above.

### Modified Examples of the Embodiment

Although an embodiment of the present invention has been described herein, the present invention is not limited to the above embodiment and various modifications may be made within the scope of the invention.

### Modified Example 1

While the battery device 33 is provided with four battery assemblies in the above embodiment, the number of the battery assemblies may be two or more.

### Modified Example 2

While the pairs of both the rear bracket and the front bracket are attached to the battery packs in the above embodiment, only one of the rear brackets and the front bracket may be attached. Additionally, while the pairs of the rear bracket and the front bracket are described as separate bodies, the pairs may be integrated. Additionally, pairs of a left bracket and a right bracket may also be used in place of the pairs of the front bracket and the rear bracket.

### Modified Example 3

While the respective head top surfaces of all the fixing bolts B1 to B4 can be seen in the top view of the battery device 33 in the above embodiment, the respective head top surfaces may also be seen from the bottom surface of the battery device 33. Even in this case, the battery pack to be replaced can be easily replaced because the fixing bolts B1 to B4 can be easily accessed with a tool from below.

### Modified Example 4

While the battery assemblies are fixed to each other by fixing the brackets to each other with the fixing bolts in the above embodiment, the battery assemblies may be fixed to each other by fixing the brackets and the battery packs with the fixing bolts.

### Modified Example 5

While an electric shovel has been used as an example of the work machine in the above embodiment, the work machine is not limited to an electric shovel. An electric wheel loader or motor grader may be exemplified as the work machine so long as the work machine is one in which the work implement is actuated with power from a battery device.

1. A battery device comprising:
a plurality of battery assemblies each having
a battery pack containing a plurality of batteries, and
one or more brackets attached to a side surfaces of the battery packs,
the plurality of battery assemblies being stacked in an up-down direction;
at least one battery assembly of the plurality of battery assemblies having
two upper level fixing parts that are fixed to a battery assembly positioned in a level above, and
two lower level fixing parts that are fixed to a battery assembly positioned in a level below, and
a distance between the two upper level fixing parts and a distance between the two lower level fixing parts being different.

2. The battery device according to claim 1, wherein
each of the plurality of battery assemblies has the two upper level fixing parts and the two lower level fixing parts,
a distance from a center in an extension direction of the side surface to the two upper level fixing parts is less than a distance from the center to the two lower level fixing parts,
positions of the two upper level fixing parts in the extension direction match positions of the two lower level fixing parts of the battery assembly positioned in the level above, and
positions of the two lower level fixing parts in the extension direction match positions of the two upper level fixing parts of the battery assembly positioned in the level below.

3. The battery device according to claim 2, wherein
intervals between the two upper level fixing parts in the extension direction increase toward the lower levels, and
intervals between the two lower level fixing parts in the extension direction increase toward the lower levels in the plurality of brackets.

4. A battery device comprising:
a plurality of battery assemblies each having
a battery pack containing a plurality of batteries, and
one or more brackets attached to a side surface of the battery pack,
the plurality of battery assemblies being stacked in an up-down direction; and
a plurality of fixing bolts fixing the plurality of battery assemblies to each other;
all head top surfaces of the plurality of fixing bolts being viewable in a top view or a bottom view.

5. The battery device according to claim 4, wherein
the plurality of fixing bolts are aligned side by side in order according to respective positions in the up-down direction in the top view or the bottom view.

6. The battery device according to claim 5, wherein
each of the brackets is fixed by two fixing bolts that are aligned side by side in an extension direction of the side surface, and
the two fixing bolts fixing one bracket of the brackets are positioned inside the two fixing bolts fixing an other bracket positioned in a level below the one bracket of the brackets in the top view or the bottom view.

7. A work machine including the battery device of claim 1, the work machine further comprising:
a travel mechanism;
a vehicle body frame supported by the travel mechanism;
a work implement unit having a work implement and a work implement driving unit; and
an electric motor configured to cause the travel mechanism and the work implement unit to operate,
the battery device being configured to supply electrical power to the electric motor.
